(19) United States
(12) Patent Application Publication
(10) Pub. No.: US 2012/0049088 A1
(43) Pub. Date: Mar. 1, 2012

(54) SYSTEMS, METHODS AND COMPUTER-ACCESSIBLE MEDIA FOR HYPERSPECTRAL EXCITATION-RESOLVED FLUORESCENCE TOMOGRAPHY

(75) Inventor: Alexander Klose, New York, NY (US)

(73) Assignee: THE TRUSTEES OF COLUMBIA UNIVERSITY IN THE CITY OF NEW YORK, New York, NY (US)

(21) Appl. No.: 13/254,955

(22) PCT Filed: Mar. 5, 2010
(86) PCT No.: PCT/US2010/026297

§ 371 Date: Nov. 14, 2011

Related U.S. Application Data
(60) Provisional application No. 61/158,232, filed on Mar. 6, 2009.

(51) Int. Cl. G01J 1/58

(52) U.S. Cl. 250/459.1; 250/458.1; 250/200

(57) ABSTRACT

An exemplary method, system, and computer-accessible medium can be provided for generating three-dimensional image information associated with a fluorescence-exhibiting arrangement within a sample. For example, it is possible to generate a first electro-magnetic radiation, to be received in the sample, at one or more wavelengths that are associated with one or more wavelengths of emission of the fluorescence-exhibiting arrangement. In addition, it is possible to generate a second electro-magnetic radiation from the sample which is caused by the fluorescence-exhibiting arrangement in response to the first electro-magnetic radiation, and generate data associated with the second electro-magnetic radiation. Then, it is possible to receive the data, and generate three-dimensional information based on the data.

### CROSS-REFERENCE TO RELATED APPLICATION(S)

This application relates to and claims priority from U.S. Patent Application Ser. No. 61/158,232 filed Mar. 6, 2009, the entire disclosure of which is hereby incorporated herein by reference.

### FIELD OF THE DISCLOSURE

The present disclosure relates to exemplary embodiments of systems, methods and computer-accessible media for hyperspectral excitation-resolved fluorescence tomography (“HEFT”).

### BACKGROUND INFORMATION

Fluorescence imaging is a biomedical imaging modality which reports on diseases and biological function in living small animals (e.g., mice, rats) by using light emitting probes. A small animal is either administered or genetically transfected with a fluorescing probe (i.e., fluorescent dye or fluorescent protein) that emits light at defined wavelengths upon excitation by an external light source.

Unlike photons used in Positron Emission Tomography (PET) or Single Photon Emission Counting Tomography (SPECT) imaging, fluorescence light in the visible and near-infrared is strongly scattered in biological tissue. Therefore, planar surface images, provided by conventional imaging technologies do not contain any information about the depth and strength of the source of fluorescence. For example, the same fluorescence surface image may be obtained for a weak fluorescence source near the surface, or a strong fluorescence source deeper inside tissue.

Some fluorescence tomography methods utilize point-like sources (e.g., optical fiber tip, focused laser beam) which illuminate the tissue surface at different locations. The light propagates into tissue and stimulates the fluorescent probes for light emission at a specific location. Following excitation inside tissue, fluorescence light is measured on the tissue surface by an optical detector. A light propagation model establishes a functional relationship between the boundary current of fluorescence light (planar images), the excitation field for given source location, and the probe concentration.

At least one of the objects of the exemplary embodiments of the present disclosure is to reduce or address the deficiencies and/or limitations of the prior art procedures and systems described herein above.

### SUMMARY OF EXEMPLARY EMBODIMENTS OF THE PRESENT DISCLOSURE

At least some of the above described problems can be addressed by exemplary embodiments of the system, method and computer accessible medium according to the present disclosure. For example, using such exemplary embodiments, it is possible to provide a system for generating at least one three-dimensional image information associated with at least one fluorescence-exhibiting arrangement within a sample, comprising a tunable source configured to generate at least one first electro-magnetic radiation, to be received in the sample, at one or more wavelengths that are associated with one or more wavelengths of emission of the at least one fluorescence-exhibiting arrangement, a detection arrangement configured to receive at least one second electro-magnetic radiation from the sample which is caused by the at least one fluorescence-exhibiting arrangement in response to the at least one first electro-magnetic radiation, and generate data associated with the at least one second electro-magnetic radiation, and a processing arrangement configured to receive the data, and generate the at least one three-dimensional image information based on the data.

The tunable source can comprise a white light source with a continuous spectrum. The wavelengths of emission can vary between approximately about 560 nm and 660 nm. The detection arrangement can comprise a charge-coupled-device camera. The tunable source can be configured to generate the at least one first electro-magnetic radiation at a first side of the sample, and the detection arrangement is configured to receive the at least one second electro-magnetic radiation from a second side of the sample.

The system can further comprise a filter arrangement provided at the second side between the sample and the detection arrangement to facilitate the second electromagnetic radiation to pass through the filter arrangement. The processing arrangement can be configured to generate the at least one three-dimensional image information by solving linear equations. The fluorescence-exhibiting arrangement can include at least one fluorophore.

Using such exemplary embodiments, it is also possible to provide a method for generating at least one three-dimensional image information associated with at least one fluorescence-exhibiting arrangement within a sample, comprising generating at least one first electro-magnetic radiation using a tunable source, to be received in the sample, at one or more wavelengths that are associated with one or more wavelengths of emission of the at least one fluorescence-exhibiting arrangement, receiving at least one second electro-magnetic radiation from the sample which is caused by the at least one fluorescence-exhibiting arrangement in response to the at least one first electro-magnetic radiation, generating data associated with the at least one second electro-magnetic radiation, and using a processing arrangement, generating the at least one three-dimensional image information based on the data.

Using such exemplary embodiments, it is also possible to provide a computer-accessible medium which contains thereon software for generating at least one three-dimensional image information associated with at least one fluorescence-exhibiting arrangement within a sample, wherein, when a processing arrangement executes the software, the processing arrangement can be configured to perform procedures comprising receiving at least one first electro-magnetic radiation from the sample which is (i) associated with at least one second electro-magnetic radiation generated using a tunable source, to be received in the sample, and (ii) caused by the at least one fluorescence-exhibiting arrangement in response to the at least one second electro-magnetic radiation, wherein the at least one second electro-magnetic radiation being provided at one or more wavelengths that are associated with one or more wavelengths of emission of the at least one fluorescence-exhibiting arrangement, generating data associated with the at least one first electro-magnetic radiation, and using a processing arrangement, generating the at least one three-dimensional image information based on the data.

These and other objects, features and advantages of the present disclosure will become apparent upon reading the following detailed description of embodiments of the present disclosure, when taken in conjunction with the appended claims.

### BRIEF DESCRIPTION OF THE DRAWINGS

The foregoing and other exemplary objects of the present disclosure will be apparent upon consideration of the following detailed description, taken in conjunction with the accompanying exemplary drawings and claims, in which like reference characters refer to like parts throughout, and in which:

FIG. 1 is an illustration of an exemplary embodiment of a combination of hyperspectral excitation-resolved fluorescence tomography procedure and system in accordance with the present disclosure;

FIGS. 2(a)-2(e) are exemplary illustrations of a phantom model with two fluorescent targets placed at different depths;

FIG. 2(f) is an exemplary illustration of a phantom model with a fluorescence image and fluorophore at different depths;

FIGS. 3(a)-3(e) are exemplary images of fluorescence light intensity for different illumination wavelengths obtained in accordance with an exemplary embodiment of the present disclosure;

FIGS. 4(a)-4(o) are exemplary image reconstruction results of quantum dot (“QD”) concentration for different depths;

FIGS. 5(a)-5(j) are exemplary image reconstructions of QD concentration using HEFT for different depths;

FIGS. 6(a)-6(e) are exemplary image reconstructions of fluorophore absorption coefficients;

FIGS. 7(a)-7(f) are exemplary images of fluorescence light taken for different excitation wavelengths;

FIG. 8 is a graph of an exemplary comparison of image reconstructions;

FIG. 9 is an exemplary graph or relative processing time of diffusion, SP_{N}, and S_{N} transport methods;

FIG. 10 is a block diagram of an exemplary embodiment of a system according to the present disclosure;

FIG. 11 is an exemplary graph of an adaptive grid refinement with two different grid levels;

FIGS. 12(a) and 12(b) are images of an exemplary generation of an anatomically correct structured Cartesian grid of a mouse based on MRI segmentation; and

FIG. 13 is a flow diagram according to an exemplary embodiment of a method of the present disclosure.

Throughout the figures, the same reference numerals and characters, unless otherwise stated, are used to denote like features, elements, components or portions of the illustrated embodiments. Moreover, while the subject invention will now be described in detail with reference to the figures, it is done so in connection with the illustrative embodiments. It is intended that changes and modifications can be made to the described embodiments without departing from the true scope and spirit of the subject disclosure.

### DETAILED DESCRIPTION OF EXEMPLARY EMBODIMENTS

### A. Exemplary Hyperspectral Excitation-Resolved Fluorescence Tomography

Hyperspectral excitation-resolved fluorescence tomography (HEFT) can utilize a single light source and exploit the spectral properties of tissue (oxy-)hemoglobin and the broad extinction spectrum of a fluorophore, such as quantum dot (“QD”) reporter probes, for exemplary image reconstruction. The fluorophore can absorb light between 560 and 660 nm. The extinction spectrum of cadmium-telluride (CdTe) QDs, for example, can extend over a few hundreds nanometers and overlap with that particular part of the (oxy-)hemoglobin absorption spectrum between approximately 560 nm and 660 nm, which shows large changes in its extinction coefficient over approximately three orders of magnitude.

Moreover, QDs can be characterized by broad extinction spectra and also by narrow emission spectra extending far into the near-infrared (NIR). Thus, NIR emitting QDs can facilitate deep tissue imaging since only a small amount of light absorption and tissue auto-fluorescence can be present in that spectral region. The spectral distance between emission and excitation wavelengths of QDs may not be limited to relatively small Stokes shifts of organic dyes and proteins. Thus, it is possible to provide a method for spectral separation of fluorescence from excitation light in accordance with an exemplary embodiment of the present disclosure.

Exemplary QD-mediated probe concentrations can be reconstructed with HEFT. These probes can be optically defined by their quantum yield η, concentration c, and extinction coefficient ε. A light propagation model, F, can establish a functional relationship between the boundary current, J⁺ of fluorescence light at r_{d}. The excitation field φ^{x}(r,λ), that stimulates QDs at position r for light emission inside tissue, can be a function of (oxy-)hemoglobin absorption at wavelength λ. The emission strength, which can be the product φ^{x}(r,λ) ηεc, of optically stimulated QDs can depend on the wavelength-dependent excitation field and, hence, will encode for the QD's location r inside tissue. Therefore, J⁺ at a single defined fluorescence wavelength can be a function of the wavelength-dependent excitation field:

J⁺(r_{d})=F[φ^{x}(r,λ) ηc(r) ε(λ)] (1)

The exemplary HEFT method/procedure according to an exemplary embodiment of the present disclosure can collect fluorescence light from only one source location and at multiple excitation wavelengths λ. This can be in contrast to current FMT methods, where boundary measurements of J⁺ are taken for multiple source locations rₛ and single excitation wavelength. Hence, measurement data of the inverse source problem of HEFT can be provided by the set J⁺(r_{d}, λ) of pairs (d, λ) of detector positions and wavelengths instead of J⁺(r(_{d}, rₛ) with source-detector pairs (s,d) of current methods. Thus, no multiple point-like sources are required at the tissue surface. Instead, a single light source with uniform macro-illumination can be employed, which can simplify the measurement process, and current planar surface imaging technology can be retrofitted for fluorescence tomography by adding a light source with a tunable wavelength-selection.

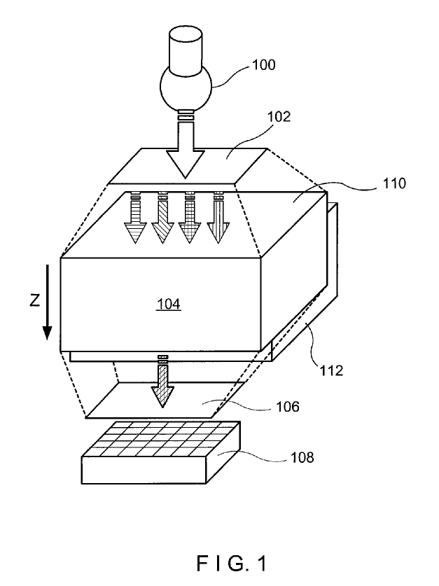

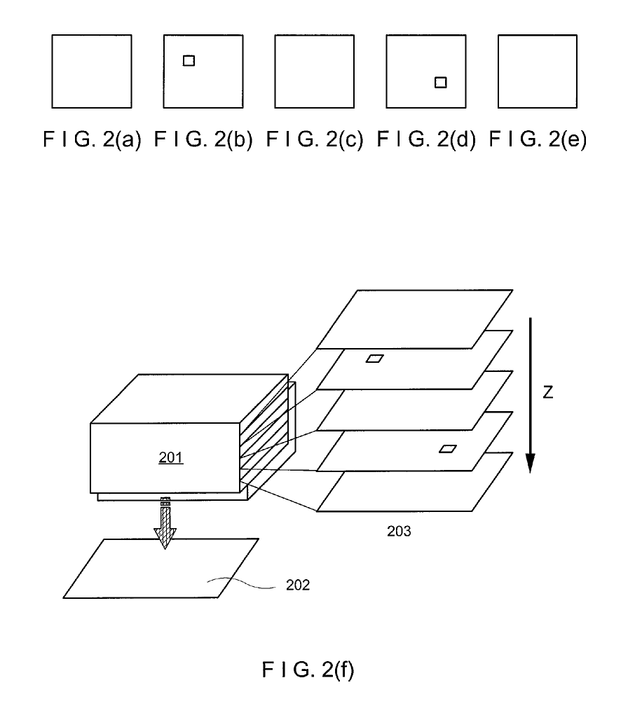

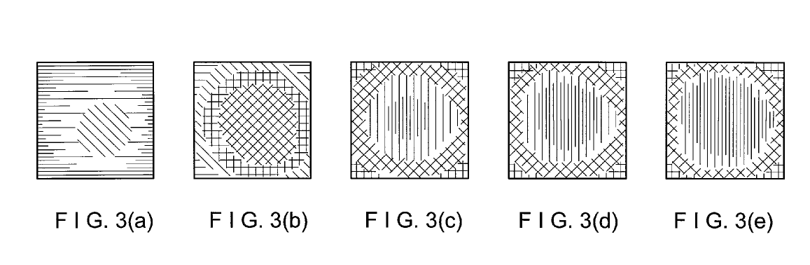

An exemplary HEFT procedure according to an exemplary embodiment of the present disclosure can be performed as shown in FIG. 1. First, e.g., a tissue surface at a first side 110 of a small animal can consecutively be illuminated with light at different wavelengths with bandwidth Δλ centered at λ. The source can be, e.g., a wavelength-selective light source 100 having a continuous spectrum. Different wavelengths λ for a fluorescence stimulation can be selected, e.g., between about 560 nm and 660 nm, with a wavelength-tunable optical filter 102 according to a largest change of (oxy-)hemoglobin extinction. Second, a medium 104, such as a defined surface area of the small animal, e.g., the dorsal or ventral side of the animal's torso, can be uniformly illuminated along a direction Z and the fluorescence light, exiting a second side 112 opposite to the side 110 of macro-illumination, can be collected with an optical detector, such as a charge-coupled-device (CCD) camera 108. Although the light source 100 and optical detector 108 are shown on opposite sides, they can also be on a same side and are not limited as such. Preferably, only QDs can be used that emit in the NIR region above about 680 nm. For example, QDs emitting at about 705 nm have a quantum yield above about η=0.9 and extinction coefficients ε between 1.2×10⁶ and 0.4×10⁶ M⁻¹ cm⁻¹ at wavelengths between about 560 nm and 660 nm. Third, at the second side 112 (detector side) of the exemplary arrangement, fluorescence light can be separated from excitation light with an optical filter 106 for fluorescence light at about 680 nm. J⁺(r_{d}, λ) can be measured by taking images of the fluorescence light on the second side 112 of FIG. 1 of the tissue surface for different illumination wavelengths of about 580 nm, 600 nm, 620 nm, 640 nm and 660 nm, as shown in FIGS. 3(a)-3(e), respectively. Approximately 10 to 20 images can be obtained, for example, for Δλ between 5 nm to 10 nm. FIG. 2(f) illustrates a model 201 having a fluorescence image 202, with fluorophore 203 at different depths along direction Z. FIGS. 2(a)-2(e) illustrate the fluorophore in different depths.

Following the exemplary fluorescence data acquisition, an exemplary image reconstruction can be performed by solving an algebraic system of linear equations:

J⁺ =A c (2)

with c being a vector of the unknown QD concentration and J⁺ being a vector of the measured boundary current. The vector c with components cₘ, can have the dimension of M voxels of the reconstruction domain that can be defined on a structured Cartesian grid. The vector J⁺ can have N×L elements J⁺_{n,1} with N being the number of detector points on the tissue surface and L being the number of excitation wavelengths. The elements of J⁺ can be ordered as follows:

J⁺=([J⁺_{1,1} . . . , J⁺_{N,1}], . . . [J⁺_{1,L} . . . , J⁺_{N,L}]) (3)

A single element A_{[n,1],m} of the matrix A_{[N L] x M} can be defined as, e.g., the partial boundary current J⁺(rₙ)=F [φ^{x}(rₘ, λ₁) ηc₀(rₘ)ε(λ₁+)] at detector point rₙ, which can be calculated by the light propagation model F for a unit concentration c₀(rₘ) at voxel rₘ and excitation wavelength λ₁. The forward model can be solved for the moments Φ₁ and Φ₂ with a finite-difference implementation of the simplified spherical harmonics equations of 3rd order (SP₃):

$$\text{?} \frac{1}{\text{?}} \text{?} \text{?} \text{?} \frac{2}{3} \text{?} \\ \text{?} \frac{\text{?}}{\text{?}} \text{?} ( \frac{\text{?}}{\text{?}} \text{?} \frac{\text{?}}{\text{?}} \text{?} ) \text{?} \frac{2}{3} \text{?} \text{?} \frac{2}{3} \text{?} \\ \text{?} \text{indicates text missing or illegible when filed} \qquad ( 4 )$$

J⁺ at the boundary with surface normal n can be obtained from Φ₁ and Φ₂ by:

$$\text{?} ( \frac{\text{?}}{\text{?}} \text{?} \frac{1}{2} \text{?} ) ( \text{?} \frac{2}{3} \text{?} ) \frac{\text{?}}{\text{?}} ( \frac{\text{?}}{} \frac{}{} \text{?} \frac{}{} ) \\ ( \frac{}{} ) \frac{}{} \\ \text{?} \text{indicates text missing or illegible when filed} \qquad ( 5 )$$

The partial-reflective boundary conditions, the reflection moments R₁, R₂, R₃, R₄, and the absorption moments μₐ₁, μₐ₂, and μₐ₄ can be found. Moreover, the excitation field φ^{x}(rₘ,λ₁) can be calculated with the SP₃ equations for each wavelength, by using an external boundary source. The algebraic system of Eq. (2) can be iteratively solved for c with an expectation-maximization (EM) method or any solver for matrix equations and solutions can be displayed as tomographic images. The SP₃ model can also be replaced by a simpler diffusion model. However, the diffusion model can lead to increased model errors at wavelengths smaller than 620 nm.

For example, a numerical tissue model with size of 3 cm×3 cm×2 cm can be used for demonstrating the performance of HEFT. The absorption and scattering coefficients can be similar to that of the bowel, as shown in Table 1 below, and can be calculated with an empirical function. The bottom side of the phantom can be uniformly illuminated with light of either one, three, five, or nine different wavelength intervals between 575 nm and 665 nm separated by Δλ=10 nm. The integrated source strength for each spectral interval can be set to 10¹² photons cm⁻² s⁻¹. As shown in exemplary images of FIGS. 2(a)-2(e), two fluorescent targets with size of 0.2 cm×0.2 cm×0.2 cm can be placed at different locations inside a model with depths of 0.8 cm and 1.4 cm. For example, FIGS. 3(a)-3(e) show exemplary images of fluorescence light intensity for different illumination wavelengths obtained using the exemplary embodiment of FIG. 1, where FIG. 3(a) shows an approximately minimum light intensity and FIG. 3(e) shows an approximately maximum light intensity. The boundary current at about 705 nm can be calculated for about 64 detector points on a side of a model, such as the lower side of the model of FIG. 1. About 5% Gaussian noise can be added to J⁺(λ₁) yielding synthetic measurement data.

FIGS. 3(a)-3(e) previously described show exemplary images of J⁺ at the lower plane of the model for five different excitation wavelengths. The QD concentration was reconstructed on a Cartesian grid with M=20,181 grid points given 64 ×9 (N×L) measurement data points. The EM method took 5,000 iterations for completion.

TABLE 1

[symbol]

| | | | |
|---|---|---|---|
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |

[symbol]

indicates data missing or illegible when filed

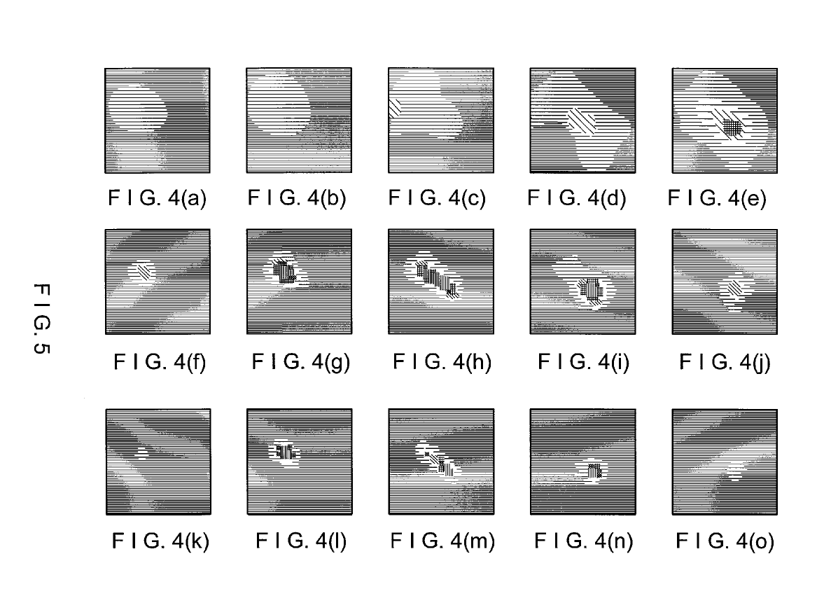

FIGS. 4(a)-4(o) show exemplary image reconstruction can result with a QD concentration for different depths measured from a model. Specifically, FIGS. 4(a)-4(e) show exemplary image reconstruction results of QD concentration at depths of 0.5 cm, 0.8 cm, 1.1 cm, 1.4 cm, and 1.7 cm, respectively, for one excitation wavelength (660 nm). FIGS. 4(f)-4(j) show exemplary image reconstruction results of QD concentration at depths of 0.5 cm, 0.8 cm, 1.1 cm, 1.4 cm, and 1.7 cm, respectively, for three different excitation wavelengths (640 nm, 650 nm, 660 nm). FIGS. 4(k)-4(o) show exemplary image reconstruction results of QD concentration at depths of about 0.5 cm, 0.8 cm, 1.1 cm, 1.4 cm, and 1.7 cm, respectively, for five different wavelength (620 nm, 630 nm, 640 nm, 650 nm, 660 nm). The original fluorophore distribution is shown in FIGS. 2(a)-2(e). The best results are obtained for the largest amount of available wavelengths as shown in the bottom row in FIGS. 4(k)-4(o).

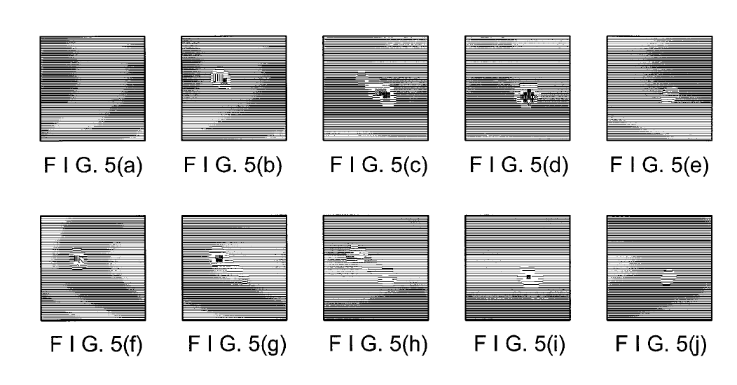

FIGS. 5(a)-5(j) show a direct comparison of HEFT results to results obtained with a current FMT technique using source-detector multiplexing. Here, a set of nine different source locations placed on the bottom plane of the tissue model were used. Hence, a reconstruction matrix A and measurement vector J⁺ had the same size for both reconstruction approaches. The simulation is done for excitation and emission wavelengths of about 680 nm and 705 nm. FIGS. 5(a)-5(e) show exemplary image reconstructions of QD concentration using HEFT for different depths of about 0.5 cm, 0.8 cm, 1.1 cm, 1.4 cm, and 1.7 cm, respectively, using wavelength-resolved excitation fields φ^{x}(λ) using nine different wavelengths. FIGS. 5(f)-5(j) show exemplary image reconstructions of QD concentration using FMT with multiplexed sources and detectors for different depths of 0.5 cm, 0.8 cm, 1.1 cm, 1.4 cm, and 1.7 cm, respectively, using wavelength-resolved excitation fields φ^{x}(λ).

Accordingly, the exemplary embodiment of the HEFT method/procedure according to the present disclosure can be an alternative approach for reconstructing fluorescent probes in scattering tissue. Exemplary HEFT procedures can exploit the broad extinction spectrum of fluorophore, such as QDs, and the large change of (oxy-)hemoglobin absorption in tissue. Exemplary HEFT procedures can simplify the measurement process because, e.g., its supercontinuous-emitting white light source with wavelength-selective filters. Thus, uniform macro-illumination does not need to rely on complex fiber optics, source arrays, diode lasers, or optical switches for spatial multiplexing of multiple sources and detectors. HEFT can be an inexpensive alternative to current FMT methods since optical surface imaging technology could readily be retrofitted to HEFT by adding wavelength-selective macro-illumination.

### B. Exemplary Results

A fluorescence light propagation model, which is part of an image reconstruction algorithm, can be based on the SP₃ equations for simple tissue geometries. Using synthetic measurement data, it can be demonstrated that hyperspectral excitation-resolved data sets can be used for reconstructing fluorescent targets with properties similar to QDs. Furthermore, image reconstruction algorithms can be developed for single-wavelength FMT with multiple source-detector pairs based on the equation of radiative transfer (ERT) and the diffusion equation that can be validated in vivo.

### i. Exemplary In Vivo Studies With Single-Wavelength FMT

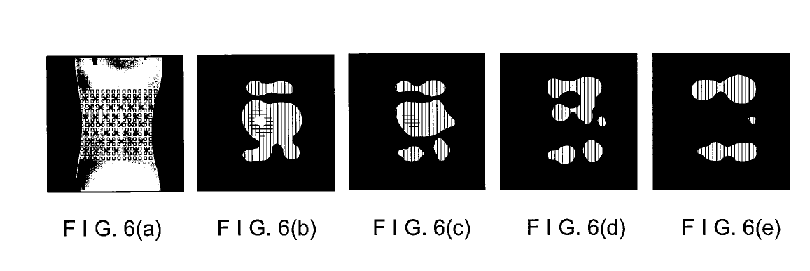

ERT can be a highly accurate model for light propagation in small animals and can overcome problems related to the use of the diffusion approximation. FIGS. 6(a)-(e) show exemplary images of an in vivo image reconstruction of a fluorophore absorption coefficient of a cancer bearing mouse. For example, a 30 g nude mouse was implanted a Lewis Lung Carcinoma (LLC) of a 4 mm diameter. After 72 hours the tumor-bearing mouse was administered a cathepsin B-sensitive fluorescent probe and placed into an imaging chamber. The mouse was illuminated by 46 sources at the backside of the animal, as shown in FIG. 6(a). Using 150 detector points the fluorophore absorption (μ=cε) of a three-dimensional domain with a size of 4 cm×4 cm×1.3 cm was reconstructed. The LLC can clearly be seen in FIGS. 6(b) and 6(c) at a depth of 0 cm and 0.2 cm, respectively. No significant fluorophore distribution was present in depths larger than 0.4 cm, as shown in FIG. 6(d), at a depth of 0.4 cm, and in FIG. 6(e), at a depth of 0.6 cm.

### ii. Exemplary Numerical Studies With HEFT

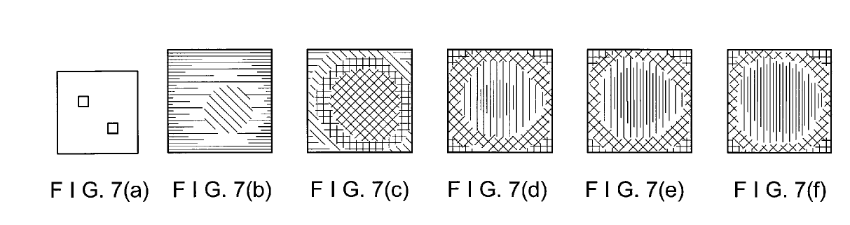

Exemplary numerical studies of the exemplary HEFT method/procedure according to the present disclosure were conducted using designed numerical phantoms that contained fluorescent targets with a broad extinction spectrum similar to the optical properties of QDs. Exemplary numerical results were compared based on HEFT to image reconstructions obtained with an FMT algorithm that uses multiplexed source-detector pairs. The numerical tissue model had a size of 3 cm×3 cm×2 cm with optical properties similar to the bowel of a small animal. The absorption and scattering coefficients of the bowel were calculated with an empirical function. The top side of the phantom was uniformly illuminated at nine different wavelength intervals (Δλ=10 nm) between 580 nm and 660 nm. The integrated source strength for each spectral interval was set to 10¹⁶ photons cm⁻² s⁻¹. Two fluorescent targets with size of 0.2 cm×0.2 cm×0.2 cm were placed at different locations inside the model with depths of 0.8 cm and 1.3 cm measured from the top plane. The optical properties chosen were: η=0.9, ε(λ)˜1.2-0.4 10⁶ M⁻¹ cm⁻¹. The partial boundary current at 705 nm was calculated for 64 detector points on the lower side of the model. 5% Gaussian noise was added to J⁺(λ₁) in order to obtain synthetic measurement data m(λ₁). The QD concentration was reconstructed on a Cartesian grid with M=20,181 grid points given 64×9 (N×L) measurement data points. The EM method took 5,000 iterations for completion. FIGS. 7(a)-7(f) show exemplary CCD camera images of fluorescence light at a bottom plane of the phantom taken for different excitation wavelengths. For example, FIG. 7(a) shows an exemplary top view of the phantom with two fluorescent targets at different depths. The fluorescence images in FIGS. 7(b)-7(f) were taken at different excitation wavelengths of 580 nm, 600 nm, 620 nm, 640 nm and 660 nm, respectively.

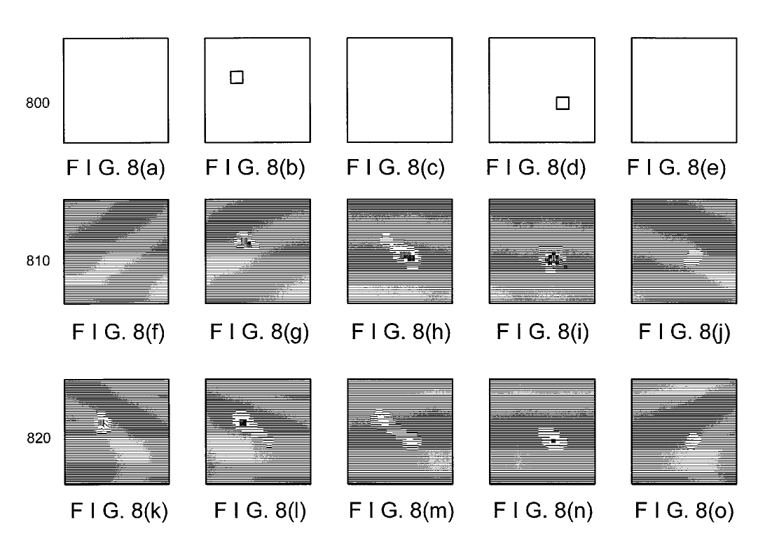

FIG. 8 shows an exemplary comparison of image reconstructions. The top row 800 of the images shows exemplary x-y planes of the phantom with fluorescent targets in two different depths. The middle row 810 of the images shows exemplary reconstruction results of HEFT for both target planes (depths of 0.7 and 1.1 cm) using nine excitation wavelengths. The bottom row 820 of the images shows exemplary results obtained from FMT with multiplexed sources and detectors. Here, a set of nine different source locations placed on the top plane of the tissue model were used. The simulation was done for excitation and emission wavelengths of 680 nm and 705 nm. As can be seen, the HEFT image reconstructions clearly provide better depth resolution by using the same amount of measurement points taken on the tissue surface.

### iii. Exemplary Light Propagation Model Based On the SP_{N} Equations

Most numerical schemes for solving the ERT have been based on the S_{N} method. The S_{N} method uses very fine Cartesian grids, and consequently leads to long processing times. This can make such approach particularly impractical for 3-D applications. Light propagation models can instead be used that use the simplified spherical harmonics (SP_{N}) approximation.

SP_{N} equations can be high-order approximations to the ERT and have several advantages when compared to S_{N} and diffusion equations. First, the SP_{N} method approximates the ERT by a set of coupled diffusion equations with Laplacian operators and avoids the complexities of the full P_{N} approximation, where mixed spatial derivatives are used. Second, the SP_{N} approximation captures most of the transport corrections to the diffusion approximation. Third, there are fewer equations to solve than with the full P_{N} or S_{N} method. Fourth, the SP_{N} system can be solved with standard diffusion solvers. Overall, SP_{N} methods provide accurate solutions, with an average error smaller than 3% for all media. Furthermore, the SP_{N} approach is at least 100 times faster than the S₁₆ method but is only 2.5 to 5 times slower than solving the diffusion equation. Therefore, the SP_{N} method according to an exemplary embodiment of the present disclosure can significantly improve fluorescence tomography, especially when light transport at wavelengths below 620 nm is considered.

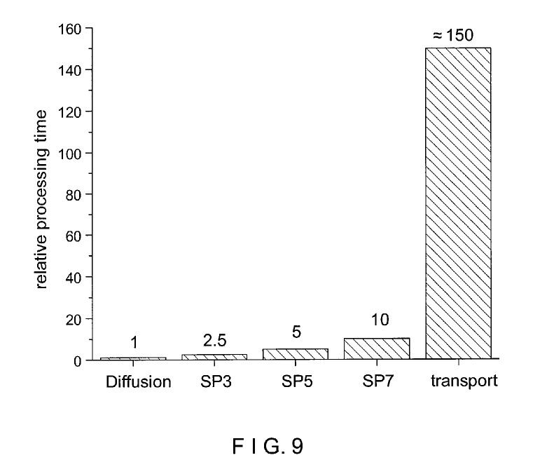

FIG. 9 shows an exemplary graph of relative processing time (y-axes) of diffusion, SP_{N}, and S_{N} transport methods (x-axes), with respect to the computation time needed for solving the diffusion equation (unit time equals 1). SP_{N} methods can be approximately 2.5 to 10 times slower and S_{N} methods can be approximately 150 times slower than solving the diffusion equation. Calculations were performed in 2-D media with small geometries (2 cm×2 cm) and large absorption as relevant to bioluminescence and HEFT imaging. The SP_{N} methods significantly outperform the diffusion approximation in model accuracy and solutions can be obtained several magnitudes faster than with the S_{N} method. This latter fact can be seen in FIG. 9.

### C. Exemplary Design And Methods

### i. Exemplary Development of Imaging Instrumentation And Phantom Studies

An exemplary arrangement according to an exemplary embodiment of the present disclosure which facilitates for a hyperspectral excitation-resolved imaging of QDs in small animals and tissue phantoms can be developed. The exemplary imaging arrangement a commercially available wavelength-tunable light source with macro-illumination, a charge-coupled device (CCD) camera with image intensifier, and a custom-designed animal bed with a heating pad, respiratory controls, and vital-sign monitoring system. Moreover, optical tissue phantoms can be designed in order to test and evaluate the performance of the imaging set-up. These tissue-like phantoms with well-defined optical properties between 560 nm and 800 nm can be made up of an Intralipid solution doped with red ink of varying concentration. Different concentrations will mimic different absorption coefficients similar to absorption coefficients of hemoglobin. The precise spatial location and distribution of QD inclusions in these phantoms will exactly be known prior to performed experiments. The experimental data can be compared to light propagation simulations based on our current SP_{N} model for simple geometries.

### a. Exemplary Development of HEFT Exemplary Arrangement

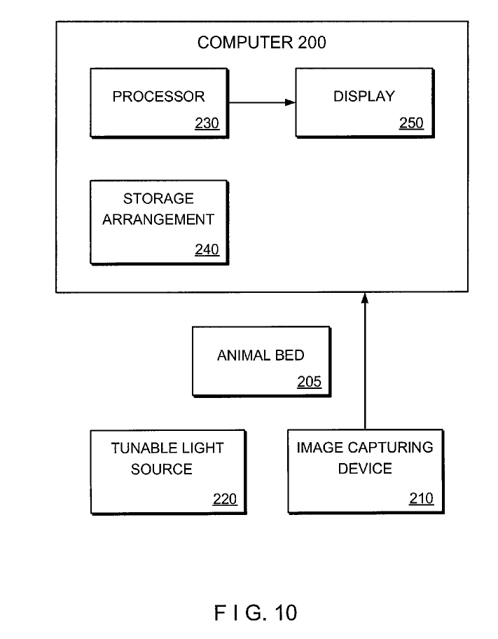

FIG. 10 illustrates a block diagram of an exemplary embodiment of a system according to the present disclosure. The exemplary system can have an image capturing device 210, such as, e.g., a camera, a light source 220, such as a wavelength-tunable white light source, and an animal bed 205. The wavelength-tunable white light source 220 can be used for uniformly illuminating the small animal surface on the animal bed 205. The wavelength-tunable white light source 220 can have a very high visible and NIR power spectral density and ultra broad spectrum of −460 nm to 2400 nm, and can provide a spectral power density in the visible light of more than 4 mW/nm, or even less than 4 mW/nm. Combining the supercontinuum light source 220 with a tunable filter, up to eight simultaneous laser lines, can be used to independently be tuned across the visible spectrum. Its tunable filter with a bandwidth of 7 nm can cover the spectral range between 450 and 700 nm, which can be ideal for illuminating QDs. The tunable filter can have a bandwidth of more or less than 7 nm as well. Thus, the total output power at a given wavelength and bandwidth can be about 28 mW.

In fluorescence tomographic imaging experiments in small animals, the camera 210 can be sensitive enough for relative small light signals. With a dynamic range of 16 bit, the camera 210 can cover enough dynamic range for imaging QDs with minimum photon count of 10³ photons s⁻¹ cm⁻². Moreover, the camera 210 can also cover the spectral range needed for imaging between 600 nm and 900 nm. For the QD experiments, the camera can be operated in the continuous wave mode (DC mode).

For the animal experiments, the animal bed 205 can hold an animal in a fixed position by means of, e.g., paw straps. The animal bed 205 can be moved without changing the relative position of the animal on the bed. The animal bed 205 can be either placed in the HEFT instrument or an IVIS Spectrum system (Caliper Sciences), but is not limited to such systems. The IVIS system can facilitate a measurement of the surface geometry of the animal with a structured light system. The surface geometry can be required for performing three-dimensional image reconstructions with reconstruction software. After the surface registration has been performed, the animal bed 205 can be removed from the IVIS system and can be placed into the HEFT set-up with trans-illumination geometry. The animal can be illuminated with light of defined wavelength (between about 560 nm-660 nm) and bandwidth (<7 nm) from the light source 220, which can excite the QDs, and an image of the fluorescence light can be taken by the image capturing device, e.g., a CCD camera, which can be at a side opposite to the light source 220. The QDs will have emission wavelengths larger than about 680 nm (Qtracker 705,800). Fluorescence images can be taken for different excitation wavelengths (minimum: 3; maximum: 15). The fluorescence light at defined wavelength λ^{m} , given by the chosen QD, can be separated from the excitation light by means of a bandpass filter centered at λ^{m} with λ^{m}>λ^{x}.

The fluorescence images can be stored on a personal computer (PC) 200 that is connected to the CCD camera 210, by, e.g., a standard USB port. The image can be provided by the image capturing device 210 to the computer 200 as data, which can be transmitted to the processor 230 and/or storage arrangement 240. The processor 230 can be configured or programmed to perform the exemplary steps and/or procedures of the exemplary embodiments of the techniques described above. For example, the processor 230 can generate three-dimensional information based on the data provided by the images from the camera 210.

According to one exemplary embodiment of the present disclosure, the data from the camera 210 can be processed by the processing arrangement 230 and/or can be stored in a storage arrangement 240 (e.g., hard drive, memory device, such as RAM, ROM, memory stick, floppy drive, etc.). The processor 230 can access the storage arrangement 140 to execute a computer program or a set of instructions (stored on or in the storage arrangement 240) which perform the procedures according to the exemplary embodiments of the present disclosure.

Thus, e.g., when the processor 230 performs such instructions and/or computer program, the processor 230 can be configured or programmed to perform the exemplary embodiments of the procedures according to the present disclosure, as described above herein. For example, the processor 230 can receive the image from the image capturing device 210 and/or the storage arrangement 240, and then generate three-dimensional data based on the data received.

A display 250 can also be provided for the exemplary system of FIG. 10. The storage arrangement 240 and the display 250 can be provided within the computer 200 or external from the computer 200. The information received by the processor 230 and the information determined by the processor 230, as well as the information stored on the storage arrangement 240 can be displayed on the display 250 in a user-readable format. For example, the display 250 can display the three-dimensional information generated by the processor 230, or the images taken by the image capturing device 210.

### b. Exemplary Design of Optical Tissue Phantoms

The initial performance of the exemplary HEFT procedure can be validated with experimental data obtained from simple tissue-phantoms. These tissue phantoms can consist of an Intralipid® 10 and red ink solution mimicking the optical properties of small animal tissue between 560 nm and 800 nm. Different ink concentrations are mimicking the spectrally dependent absorption coefficient. A cubic glass container can be used with dimensions of 2 cm×2 cm×2 cm containing water-diluted Intralipid 10 with concentrations between 5% to 10%, which pertain to reduced scattering coefficients of μₛ′=7 cm⁻¹ to μₛ′=14 cm⁻¹. The optical properties of Intralipid have been published in literature and, hence, will be used as reference. Different concentrations of red ink specify the absorption coefficient, which we will vary between μₐ=0.01 cm⁻¹ and μₐ=5 cm⁻¹. Single and multiple cuvettes (diameter of less than about 2 mm) can be placed with Qtracker QDs with emission wavelengths 655 nm (with different bandpass filter above 640 nm), 705 nm, and 800 nm, inside the Intralipid phantom and record surface images in transillumination.

### c. Comparison of Experimental Data With SP_{N} Solutions

The validation process for estimating the accuracy and model errors of current SP_{N} light propagation model can be based on the developed exemplary experimental HEFT instrumentation and phantom designs. 3D simulations can be performed on simple numerical phantoms and the results compared to experimental data obtained from our designed tissue phantoms for different wavelengths between 560 nm and 800 nm. First, the SP_{N} model error for simulating excitation light at different wavelengths can be validated. Second, SP_{N} model errors for the fluorescence light emitted by Qtracker QDs at 655 nm, 705 nm, and 800 nm can be validated. Then, the impact of incorrect optical parameters (absorption, scattering, refraction index) on the simulated boundary flux can be analyzed.

### ii. Exemplary Development of Imaging Software For In Vivo Studies

Based on the light propagation model for simple geometries, a SP_{N} reconstruction procedure for in vivo imaging of small animals can be provided. An adaptive grid refinement (AGR) method/procedure can be implemented that facilitates a correct modeling of the curved boundaries encountered in small animal imaging. To test the algorithms image reconstructions can be performed with synthetic data where the distribution of QDs and the optical tissue properties are all known. Numerical phantoms can be useful for finding implementation errors in the reconstruction code and allowing sensitivity analyses investigating the affect of measurement noise, tissue heterogeneity, and number and range of different wavelengths of the multispectral data sets. Last, an image reconstruction can be performed based on experimental data obtained from simple tissue phantoms.

### a. Exemplary AGR Method For Curved Geometries

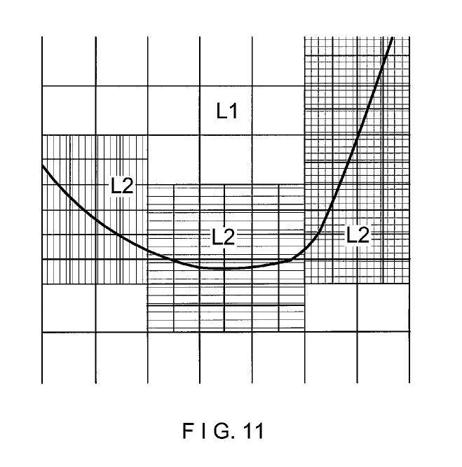

The currently existing SP_{N} code uses single structured Cartesian grids that describe a parallelepiped. This can be insufficient for in vivo studies because the small animal has curved or irregular geometries. Since the use of unstructured grids for irregular geometries involves considerable numerical overhead, which consequently increases computation time, structured grids with Cartesian coordinates can be used. These structured grids can be characterized by regular connectivity, i.e., the points of the grid can be indexed and the neighbors of each point can be calculated rather than be looked up. Structured Cartesian grids have several advantages when compared to unstructured grids. An important advantage when solving the SP_{N} equations is that fast iterative solvers of the algebraic system of equations can be used. These solvers may not be available for unstructured grids. The code can be applicable to more complex geometries such as the complex tissue surface of a small animal, but keeping structured Cartesian grids as underlying spatial discretization scheme. Thus, an AGR method/procedure according to an exemplary embodiment of the present disclosure can be implemented, which can handle complex irregular geometries with high numerical accuracy and little computational effort when compared to methods based on unstructured grids. The exemplary AGR method/procedure can solve SP_{N} equations on a composite grid L with different spatial refinement levels L₁, L₂, L₃, . . . Lₓ (hⱼ varies). As shown in the graph of FIG. 11, Grid L₁ can be a very coarse grid, and Grid L₂ can be a refined grid where the spatial difference of adjacent grid point of L₁ is cut into half as shown. First, the SP_{N} equations can be solved on the spatial grid on the coarse level L₁. Next the conditions at the coarse-fine level interface can be interpolated and applied to the boundary of the fine grid level L₂. The SP_{N} equations can be solved on that spatial subdomain with grid level L₂. At the fine-coarse level interface fluence leaving the fine grid level L₂ are then averaged and applied to the boundary of the coarse grid level L₁. Using the modified fluence distribution on grid level L₁ a new coarse grid solution is sought again by sweeping through the grid. At this time the solution on L₁ is influenced by the solution of the fine grid level L₂. When light passes an interface from the coarse grid level L₁ to the finer grid L₂, the interface fluence is interpolated with a piecewise constant operator, whereas when the light passes from the fine to the coarse grid level, the fluence is averaged using an area averaged operator. Iteration between the levels continues until convergence.

### b. Exemplary Image Reconstructions With Synthetic Measurement Data

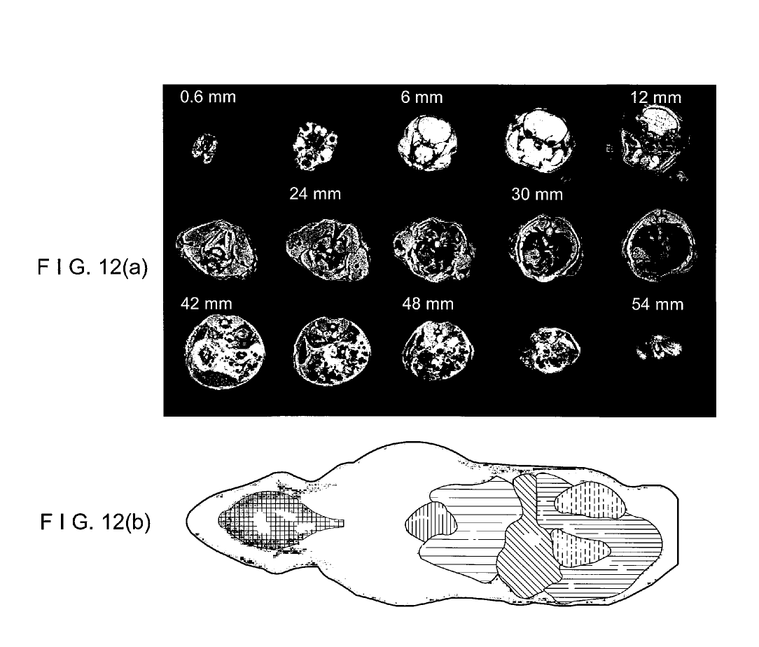

To test the reconstruction code, numerical simulation studies can be performed. In numerical simulations, a total control can be obtained over all reconstruction parameters involved, and the image reconstruction algorithm can be evaluated under optimal conditions. A given optically uniform or non-uniform medium with known QD distributions is used and the S_{N} forward model can be applied to generate noise-corrupted multi-spectral detector readings. These detector readings, which correspond to planar camera images, are then input to the image reconstruction code based on the SP_{N} model, which recovers the known QD distribution. When the fundamental properties of the code are determined in simple uniform media, numerical studies of anatomically correct mouse models derived from MRI data sets can be analyzed. MR images can be segmented by different gray values using Matlab® and optical parameters will be assigned to different tissue types. The segmented 2-D slices can be input to a developed grid generator for structured Cartesian grids with AGR. An example of magnetic resonance images (MRI) of a small animal mouse are shown in FIG. 12(a), and a surface-rendered numerical model based on a single structured Cartesian grid derived from segmented MRI images is shown in FIG. 12(b), which illustrates the generation of an anatomically correct structured Cartesian grid of a mouse based on MRI segmentation. The initial validation of the image reconstruction code will establish a thorough foundation for the in vivo studies. The reconstructed images can be compared to the original target object, i.e. numerical tissue phantom. The image quality will be measured by calculating the correlation coefficient ρₐΕ[−1,1] and the deviation factor ρ_{b}Ε[0,∞). A large value of ρₐ shows a high correlation between the reconstructed image and the target image and is indicative of a successful reconstruction. On the other hand ρ_{b} should be as small as possible.

This exemplary study can determine which wavelengths of the excitation spectrum within the range of about 560 nm and 660 nm can result in best image reconstructions. It can also be determined how many measurement points on the tissue surface need to be employed for image reconstruction. Such exemplary study can also indicate how large the field of view of the camera system needs to be in order to obtain best image reconstruction results.

### c. Image Reconstructions With Experimental Phantom Data

Uniform tissue models can be used with simple geometry to quantify the accuracy of QD location, absolute value recovery, uncertainties in correct camera position, and uncertainties in the optical parameters of the medium on the performance of the code. These phantoms can consist of Intralipid/red ink solutions with uniform optical properties and with one or more cuvettes with QDs. The absorption coefficient is a function of wavelength and can be controlled by the red ink solution mimicking hemoglobin absorption spectrum from about 560 nm, and up to 800 nm. These studies can be performed for different sets of excitation wavelengths between about 560 nm and 660 nm in incremental steps of about 7 nm (spectral bandwidth of light source). The concentration of QDs in cuvettes can be locally changed to mimic the effect of different QD uptake and target-binding in tissue. In this way the detection limits and sensitivity can be assessed. For example, by step-wise increasing the QD concentration in small areas of the phantom, it can be estimated how strong these changes need to be before our reconstruction code will detect them.

### iii. Exemplary In Vivo Studies of Anti-Angiogenic Therapy

After having developed and validated the imaging instrumentation and software with simple tissue phantoms, the HEFT method can be applied to study angiogenesis and anti-angiogenic drug therapy in small animals. The experiments proposed in this aim are primarily designed to validate and test the potential of HEFT. To that end, different tumor models can be imaged that have already been well characterized in non-imaging studies. The results obtained can provide a thorough basis for future studies in optical vascular imaging and in cancer research in general.

To test the hardware and software developed, longitudinal imaging studies can be performed using targeted and non-targeted QDs in three different tumor models, in which focus can be given on four different imaging aspects of angiogenesis and therapy. First, extravasation and changes in vessel permeability with non-targeted QDs during angiogenesis can be imaged. Second, αᵥβ₃ integrin-targeted QDs for studying up-regulation of integrins during angiogenesis can be imaged. Third, longitudinal imaging studies of αᵥβ₃ integrin expression caused by VEGF inhibition with anti-angiogenic drug therapy can be performed. αᵥβ₃ integrin-targeted QD can be developed by conjugating them to RGD (Arg-Gly-Asp) peptides. Last, targeted and non-targeted QDs can be used in the same small animal and multiplex-imaging of QDs with different emission wavelengths (“colors”) can be performed to study simultaneously extravasation and integrin expression. These imaging studies can facilitate the determination of the sensitivity and accuracy of the exemplary HEFT procedure by comparing them to histo-pathological results.

### a. Exemplary Synthesis of Non-/Targeted QD Probes

Commercially available PEG-coated Qtracker (Invitrogen Inc.) probes for non-targeted imaging of vessel permeability and extravasation can be used. These probes with a wide spectrum of different emission wavelengths (about 655 nm, 705 nm, 800 nm) can commercially be obtained and further biochemical modification is unnecessary. RGD-labeled QD probes can be synthesized for targeted imaging of αᵥβ₃ integrin expression in tumor vasculature. Probe synthesis can be performed, in which the best choice of wavelength for QD selection will be based on prior studies described above.

### b. Small Animal Models

Various small animal models can be used that include SKNEP1 renal sarcoma, a hepatoblastoma (HUH-6), and neuroblastoma (NGP). Tumor cells of each type of cancer can be implanted into the renal parenchyma of NCR nude mice and will be allowed to grow for 4 weeks. The studies above have established that different tumors display qualitatively and quantitatively distinct responses to anti-VEGF treatment. For example, it was observed that SKNEP1 tumors, which are highly responsive to a VEGF inhibition, show anti-vascular effects as early as 24 hours after treatment, while the less responsive neuroblastoma does not show these effects. Therefore, three tumor models can be used for longitudinal imaging studies of anti-angiogenic therapy.

### c. Imaging of Extravasation And Vessel Permeability

The EPR (“enhanced permeability and retention”) effect with increased extravasation can be pronounced in leaky tumor vasculature. This effect was studied in mice with SKNEP1 xenografts and eight controls. After injection of 2 nmol non-targeted PEG-coated Qtracker705 dots into the tail vein of an anesthetized (isoflurane) nu/nu mouse, the extravasation is monitored for the first three hours by taking images with multispectral excitation every 20 minutes. 24 hours later, five days, and ten days later, the experiment with the same animal was repeated. The same procedure was done for eight control mice. All data sets were input to the image reconstruction code and the 3D distribution of QDs were calculated. The vascular volume fraction (VVF=[QD]_{T}/[QD]_{B}), which is the ratio of QD uptake in tumors ([QD]_{T}—to be reconstructed) and in blood ([QD]_{B}—already known prior to experiment), was determined in order to study the natural course of angiogenesis. To quantify the QD uptake in the tumor of each animal, the reconstructed OD concentration was integrated over a volume area of interest that is defined by the full-width-at half maximum with respect to the largest OD concentration observed in the animal. For each cohort, the mean and standard deviation of the VVF at all time points is determined. After the last imaging study has been finished (10 days), the tumors were removed, fast frozen, and cut into 5 μm slices. The microvessel density, M_{d}, was determined after staining and the results were correlated to the VVF values determined by the image reconstructions. A linear relationship was found between VVF and M_{d}. This imaging experiment allows testing and validation of the imaging sensitivity for monitoring extravasation in vivo and development of tumor vasculature by means of calculating the VVF.

### d. Exemplary Imaging of αᵥβ₃ Integrin Expression

αᵥβ₃ integrin plays a key role in tumor angiogenesis and is upregulated in almost all tumor vasculature. Using synthesized RGD-labeled QDs, it is possible to directly image and quantify integrin expression in vivo. Integrin expression were imaged with QD705-RGD in mice with SKNEP1 tumor, controls with no tumor and QD705-RGD, and controls with tumor but with non-targeted QD705 probes. After injection of QD705-RGD through tail vein, the animal was imaged for a given set of different excitation wavelengths (min: 5, max: 15) at time points: 20 min, 60 min, two hours, four hours, eight hours, and 24 hours post-injection. The fluorescence data sets become input to the image reconstruction code, and the 3D bio-distribution of QD705-RGD binding in vivo was reconstructed. Mice were sacrificed after 8 hours post-injection, and tumors were harvested and imaged with an IVIS Spectrum. In comparison, to determine αᵥβ₃ integrin binding affinity of QD705-RGD, live and fixed cells of the SKNEP1 tumor were blocked with 0.1% bovine serum albumin, and stained with 1 nM QD705, QD705-RGD, and examined under the microscope (Carl Zeiss, Germany).

### iv. Exemplary Methods

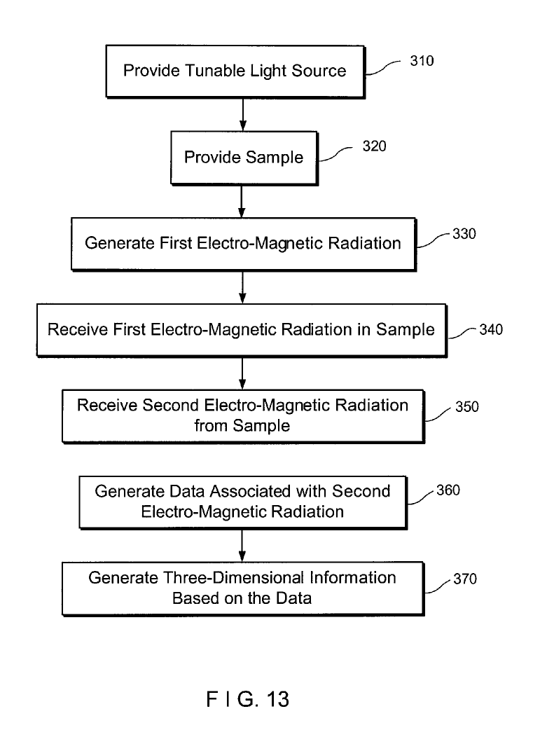

FIG. 13 illustrates a flow diagram according to an exemplary method for generating at least one three-dimensional image information associated with at least one fluorescence-exhibiting arrangement within a sample. Initially, at 310, a tunable light source can be provided. Then, at 320, a sample can be provided, such as an animal or another biological structure. At 330, using the tunable light source, a first electro-magnetic radiation can be generated using the tunable source, and then the first electro-magnetic radiation is received in the sample, at 340, at one or more wavelengths that are associated with one or more wavelengths of emission of the at least one fluorescence-exhibiting arrangement. The fluorescence-exhibiting arrangement can include at least one fluorophore, such as a nanoparticle, organic dye, fluorescent protein, etc.

At 350, a second electro-magnetic radiation is received from the sample which is caused by the at least one fluorescence-exhibiting arrangement in response to the at least one first electro-magnetic radiation. At 360, data associated with the at least one second electro-magnetic radiation is generated. Then, at 370, three-dimensional information can be generated based on the data. This can be performed by a processing arrangement.

The exemplary method and system described in the present disclosure provides a hyperspectral excitation-resolved fluorescence tomography system that makes used of the particular properties of QDs. The exemplary optical system and method can be a highly sensitive assay for monitoring anti-angiogenic drug therapy in small animals. Due to its relative technological simplicity and unique design, when compared to MRI or PET, this approach can be easily accessible in biomedical research and drug development. The impact of such exemplary methods and systems can extend to research and application of and for tumor angiogenesis. QDs offer a platform for multiplexed fluorescence imaging with different targets in the same animal. Different cellular targets or signaling pathways could be imaged simultaneously and many different aspects of cancer therapy and other diseases could be studied. For example, QDs can be good candidates for voltage-sensitive probes because of their physical size comparable to the thickness of cell membranes and their electronic properties (semiconductor). A current disadvantage of ODs may be that they cannot be used for in vivo imaging in patients due to the toxicity of QDs. However, given the development of smaller, less-toxic, self-illuminating, multifunctional QDs and further improvement of the conjugation strategy, QDs would likely achieve optimal tumor-targeting efficacy with acceptable toxicity profile for clinical translation.

The light source for fluorescence stimulation of quantum dots (QDs) can have an emission spectrum between about 560 nm and 700 nm, and the spectral range can be defined by the steepest change of the extinction coefficient of hemoglobin (Hb) and oxy-hemoglobin (HbO2) in tissue. The light source can either be a continuously emitting “white” light source with tunable wavelength selection (e.g., acousto-optic tunable filter[AOTF], set of interference filters, set of absorption filters), or can be a set of discrete emitting light sources that emit light at a defined wavelength with narrow spectral bandwidth (e.g., laser, laser diode), for example: He—Ne (594 nm, 612 nm, 632 nm), Ruby (628 nm), Kr-ion (647 nm).

There are certain benefits of the exemplary three-dimensional (3D) image reconstruction of QDs, such as a determination of spatial 3D location of QD based reporter probes inside a small animal, a determination of correct concentration of QD based reporter probes inside a small animal, and spatial location and concentration of QD reporter probes directly translates into correct spatial location and concentration of target proteins, cell surface receptors, or antibody in living animal, without the need of scarifying the animal for histo-pathological examination.

Further, 3D tomography (with the exemplary HEFT procedure) can facilitate spatio-temporal studies of reporter probes (long-term studies) in vivo. The exemplary HEFT procedure can accelerate drug development, since in vivo imaging studies can be performed in the same animal over a long period of time without scarifying the animal. It can reduce costs and biological variance, because less animals are needed for studies. The exemplary HEFT procedure can be significantly less expensive, because no nuclear probes are required (that are produced with cyclotrons), imaging equipment is technologically simple. The exemplary HEFT procedure can be safe, because no radio-nuclear probes are used, which require specifically designated facilities and trained personnel. Quantitative in vivo 3D imaging of QD probes assist in identifying, e.g., the expression level of targeted proteins, expression levels of cell surface receptors (VEGF, alpha-beta integrins), vascular volume fraction in tumor-angiogenesis, etc.

Optical probes can have an overlapping absorption spectrum with hemoglobin/oxy-hemoglobin within the spectral range of about 560 nm-700 nm, and a broad absorption spectrum with full-width half maximum (FWHM) of at least about 50 nm.

Exemplary embodiments of systems, methods and computer accessible media can be provided which can utilize, e.g., a hyperspectral excitation-resolved fluorescence tomography (HEFT) procedure. It is noted that an exemplary computer-accessible medium can be a storage arrangement (e.g., hard drive, floppy disk, memory stick, RAM, ROM, etc., and/or combination thereof) having thereon instructions which configure a processing arrangement, such as a computer, to perform such an exemplary HEFT procedure. Such exemplary embodiments can use spectral properties of tissue hemoglobin for, e.g., a three-dimensional image reconstruction of fluorescence reporter probes, such as quantum dot (QD) probes, inside the tissue. Using such exemplary embodiments, it is possible to utilize multiple electro-magnetic (EM) radiation (e.g., light) source, and a single EM or light source with a tunable wavelength selection, so as to stimulate fluorescence within the tissue. Moreover, it is possible, according to another exemplary embodiment of the present disclosure to use planar surface imaging technology systems and methods for fluorescence tomography, without the use of elaborate source-detector multiplexing.

According to one exemplary embodiment of the present disclosure, the excitation field that stimulates fluorescence probes, such as QD probes or fluorescence dyes for light emission inside the tissue, is a function of (oxy-)hemoglobin absorption at a particular wavelength. The emission strength of the optically stimulated probes (e.g., QD probes) can depend on the wavelength-dependent excitation field, and thus can obtain information and/or encode for the location of the probes inside the tissue. Therefore, the fluorescence images (e.g., three-dimensional images) obtained at the tissue surface can be a function of the wavelength-dependent excitation field. The exemplary embodiments of the systems, methods and computer-accessible medium can collect the fluorescence light, e.g., for a single source location and at multiple excitation wavelengths (or for multiple source locations). Such exemplary operation, arrangement and method are different from the conventional fluorescence tomography technology, where boundary measurements are taken for multiple source locations and using single excitation wavelength, in addition to the lack of the conventional techniques and systems to generating the three-dimensional images.

Further, exemplary measurement data of the inverse source problem of the exemplary HEFT procedure can be provided, based on the exemplary embodiments of the present disclosure, by a set of wavelength-detector pairs instead of source-detector pairs of conventional methods. Thus, it is not necessary to use multiple point-like sources at the tissue surface, since, e.g., a single light source with uniform macro-illumination can be employed. Such exemplary arrangement can simplify the measurement process, and existing planar surface imaging technology may be modified in accordance with the exemplary embodiments of the present disclosure for a fluorescence tomography by adding a light source with tunable wavelength-selection, and/or generating, e.g., three-dimensional images.

According to another exemplary embodiment of the present disclosure, it can be beneficial to obtain a surface geometry for performing three-dimensional image reconstructions using the exemplary systems, methods and computer accessible medium. For example, such geometry can be performed with the use of a surface registration associated with the surface of the sample. The sample can be illuminated with EM radiation (e.g., light) of defined wavelength (e.g., between about 560 nm -660 nm) and bandwidth (e.g., about <7 nm) which can excite the probes. Further, an image of the fluorescence light can be obtained by a detector (e.g., a CCD camera), for example, at a side opposite to the source, but is not limited to such.

The foregoing merely illustrates the principles of the present disclosure. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the present disclosure and are thus within the spirit and scope of the present invention. In addition, to the extent that the prior art knowledge has not been explicitly incorporated by reference herein above, it is explicitly being incorporated herein in its entirety. All publications referenced herein above are incorporated herein by reference in their entireties. In the event of a conflict between the teachings of the present disclosure and those of the incorporated document, the teachings of the present disclosure.

What is claimed is:

1. A system for generating at least one three-dimensional image information associated with at least one fluorescence-exhibiting arrangement within a sample, comprising:
a tunable source configured to generate at least one first electro-magnetic radiation, to be received in the sample, at one or more wavelengths that are associated with one or more wavelengths of emission of the at least one fluorescence-exhibiting arrangement;
a detection arrangement configured to receive at least one second electro-magnetic radiation from the sample which is caused by the at least one fluorescence-exhibiting arrangement in response to the at least one first electro-magnetic radiation, and generate data associated with the at least one second electro-magnetic radiation; and
a processing arrangement configured to receive the data, and generate the at least one three-dimensional image information based on the data.

2. The system according to claim 1, wherein the tunable source comprises a white light source with a continuous spectrum.

3. The system according to claim 1, wherein the wavelengths of emission vary between approximately about 560 nm and 660 nm.

4. The system according to claim 1, wherein the detection arrangement comprises a charge-coupled-device camera.

5. The system according to claim 1, wherein the tunable source is configured to generate the at least one first electro-magnetic radiation at a first side of the sample, and the detection arrangement is configured to receive the at least one second electro-magnetic radiation from a second side of the sample.

6. The system according to claim 5, further comprising a filter arrangement provided at the second side between the sample and the detection arrangement to facilitate the second electromagnetic radiation to pass through the filter arrangement.

7. The system according to claim 1, wherein the processing arrangement is configured to generate the at least one three-dimensional image information by solving linear equations.

8. The system according to claim 1, wherein the at least one fluorescence-exhibiting arrangement includes at least one fluorophore.

9. A method for generating at least one three-dimensional image information associated with at least one fluorescence-exhibiting arrangement within a sample, comprising:
generating at least one first electro-magnetic radiation using a tunable source, to be received in the sample, at one or more wavelengths that are associated with one or more wavelengths of emission of the at least one fluorescence-exhibiting arrangement;
receiving at least one second electro-magnetic radiation from the sample which is caused by the at least one fluorescence-exhibiting arrangement in response to the at least one first electro-magnetic radiation;
generating data associated with the at least one second electro-magnetic radiation; and
using a processing arrangement, generating the at least one three-dimensional image information based on the data.

10. The method according to claim 9, wherein the at least one first electro-magnetic radiation is generated at a first side of the sample, and the at least one second electro-magnetic radiation is received from a second side of the sample.

11. The method according to claim 10, further comprising providing a filter arrangement at the second side of the sample to facilitate the second electromagnetic radiation to pass through the filter arrangement.

12. The method according to claim 9, wherein the processing arrangement is configured to generate the at least one three-dimensional image information by solving linear equations.

13. The method according to claim 9, wherein the at least one fluorescence-exhibiting arrangement includes at least one fluorophore.

14. The method according to claim 9, wherein the tunable source comprises a white light source with a continuous spectrum.

15. A computer-accessible medium which contains thereon software for generating at least one three-dimensional image information associated with at least one fluorescence-exhibiting arrangement within a sample, wherein, when a processing arrangement executes the software, the processing arrangement is configured to perform procedures comprising:
receiving at least one first electro-magnetic radiation from the sample which is (i) associated with at least one second electro-magnetic radiation generated using a tunable source, to be received in the sample, and (ii) caused by the at least one fluorescence-exhibiting arrangement in response to the at least one second electro-magnetic radiation, wherein the at least one second electro-magnetic radiation being provided at one or more wavelengths that are associated with one or more wavelengths of emission of the at least one fluorescence-exhibiting arrangement;
generating data associated with the at least one first electro-magnetic radiation; and
using a processing arrangement, generating the at least one three-dimensional image information based on the data.

16. The computer-accessible medium according to claim 15, wherein the at least one fluorescence-exhibiting arrangement includes at least one fluorophore.

17. The computer-accessible medium according to claim 15, wherein the at least one first electro-magnetic radiation is generated at a first side of the sample, and the at least one second electro-magnetic radiation is received from a second side of the sample.

18. The computer-accessible medium according to claim 17, wherein the tunable source comprises a white light source with a continuous spectrum.

19. The computer-accessible medium according to claim 15, wherein the wavelengths of emission vary between approximately about 560 nm and 660 nm.

20. The computer-accessible medium according to claim 15, wherein the processing arrangement is configured to generate the at least one three-dimensional image information by solving linear equations.
